(19) United States
(12) Patent Application Publication
(10) Pub. No.: US 2020/0331223 A1
(43) Pub. Date: Oct. 22, 2020

(54) DEVICE AND METHOD FOR PRODUCING A COMPRESSION MOULDED BODY

(71) Applicant: SCHUNK KOHLENSTOFFTECHNIK GMBH, Heuchelheim (DE)

(72) Inventor: Guenter Rinn, Lahnau (DE)

(21) Appl. No.: 16/305,638

(22) PCT Filed: May 8, 2017
(86) PCT No.: PCT/EP2017/060866

§ 371 Date: Nov. 29, 2018

(30) Foreign Application Priority Data
Jun. 8, 2016 (DE) 10 2016 110 595.3
Jun. 23, 2016 (DE) 10 2016 211 290.2

(51) Int. Cl. B30B 11/08; B22F 3/03

(52) U.S. Cl. CPC B30B 11/085; B30B 15/30; B22F 3/03

(57) ABSTRACT

The invention relates to a device (10) for producing a compression moulded body (11), having at least one first moulded layer, wherein the device has an upper ram arrangement (12) and a lower ram arrangement (13), with in each case at least one ram unit (15, 16), and a mould (14), wherein the ram unit has at least one ram tool (17), wherein the ram tools are configured such that they can be displaced axially with respect to one another in a die (19) of the mould, in such a way that moulding segments can be configured in the mould by means of the ram tools, wherein the device has a filling device (27), wherein the die can be filled with moulding material by means of the filling device, wherein the upper ram arrangement and the lower ram arrangement in each case have a multiplicity of circularly annually arranged ram units, wherein the mould is configured as a die plate (18) and, together with the ram units, configured as a rotor which is configured such that it can be rotated about an axis, wherein the device has a feed device (30), wherein a film (31) can be fed to the rotor by means of the feed device, such that it lies between a ram tool and a die which is configured in the die plate, wherein a layer can be configured on the first moulding layer by means of the film.

The invention pertains to a device and a method for producing a compression moulded body with at least one first moulded layer, wherein the device comprises an upper ram arrangement and a lower ram arrangement, which respectively have at least one ram unit, and a mould, wherein the ram unit has at least one ram tool, wherein the ram tools are designed for being axially displaceable relative to one another in a die of the mould in such a way that mould segments can be formed in the mould by means of the ram tools, wherein the device has a filling device, and wherein the die can be filled with moulding material by means of the filling device.

Such devices and methods are sufficiently known and routinely used for the production of single-layer and a multi-layer compression moulded bodies of any type. For example, a compression moulded body may be a carbon brush or a body produced of another moulding material, e.g. metal powder. It is essential that the compression moulded body comprises at least two distinguishable moulded layers. A carbon brush may comprise, for example, a moulded layer of graphite with a copper fraction and an additional moulded layer of graphite with a silver fraction. The moulding material usually consists of a powder mixture and is compressed in the device, if applicable by using a binder. However, the compression moulded body may also be subjected to a heat treatment such as sintering after the compression process.

DE 10 2006 006 313 A1 discloses a press for producing a multi-layer carbon brush. The press comprises a mould, in which a single die is formed, wherein ram tools of an upper and a lower ram unit are arranged in the die so as to be axially displaceable relative to one another. In order to produce the compression moulded body, it is proposed to initially fill a first and then a second mould segment with different moulding materials and to subsequently form the compression moulded body by compressing the moulding material in the die.

The particular disadvantage of such a press can be seen in the limited production capacities because the pressing speed is limited by the mass of the ram tools. For example, a maximum of 25 to 100 strokes per minute can currently be reached in an economically feasible machine operation. In multi-layer compression moulded bodies or carbon brushes, it is furthermore known to form an insulation layer between a first moulded layer and a second multiplier. This can be realized by arranging a separation layer in the form of a dielectric film between the first moulded layer and the second moulded layer. However, the introduction of the film then requires two strokes of the press per compression moulded body because the different moulding materials have to be filled into the die in succession and with interposition of the film. In this case, the film particularly may be punched out with the ram tool. The production of such a compression moulded body is costly due to the required number of strokes at a limited pressing speed.

The present invention is therefore based on the objective of proposing a device, a utilization of a device, as well as a method for producing a multi-layer compression moulded body, which respectively allow a cost-efficient production of compression moulded bodies in large quantities.

This objective is attained by means of a device with the characteristics of claim 1, a utilization of a device with the characteristics of claim 19 and a method with the characteristics of claim 20.

The inventive device for producing a compression moulded body with at least one first moulded layer comprises an upper ram arrangement and a lower ram arrangement, which respectively have at least one ram unit, and a mould, wherein the ram unit has at least one ram tool, wherein the ram tools are designed for being axially displaceable relative to one another in a die of the mould in such a way that mould segments can be formed in the mould by means of the ram tools, wherein the device has a filling device, wherein the die can be filled with moulding material by means of the filling device, wherein the upper ram arrangement and the lower ram arrangement respectively comprise a multiplicity of annularly arranged ram units, wherein the mould is realized in the form of a die plate and forms a rotor, which is designed to be rotatable about an axis, together with the ram units, wherein the device has a feed device, wherein a film can be fed to the rotor by means of the feed device such that it lies between a ram tool and a die formed in the die plate, and wherein a layer can be produced on the first moulded layer by means of the film.

The mould in the form of a die plate therefore lies between the ram units of the upper and the lower ram arrangement, which are respectively arranged annularly, wherein the ram units can rotate about the axis together with the die plate. A multiplicity of dies is likewise arranged annularly in the die plate and realized in such a way that at least two opposite die tools or one guide tool pair are axially displaceable relative to one another in an associated die of the mould. A ram tool of a ram unit of the upper ram arrangement and a ram tool of a ram unit of the lower ram arrangement are then movable in the die in such a way that they correspond to one another and can form a mould segment in the die. The mould segment can then be filled with moulding material by means of the filling device, wherein the film is arranged between the ram tool and the die plate or die by means of the feed device after the filling process. The film can be cut out or punched out with a stroke of the ram tool and the first moulded layer can be pressed. The film therefore forms the layer on the first moulded layer. The moulding material may basically consist of any material that can be processed in such a press. The moulding material is preferably supplied in granular form or powder form or in the form of a powder mixture of a granulate mixture, wherein the same moulding material or different moulding materials can be used for producing the first moulded layer and additional moulded layers. The moulding material used preferably consists of graphite powder, for example, with a metal powder fraction, but may also consist exclusively of metal powder. The film for forming the layer may consist of a dielectric film, for example a plastic film, but any other type of film-like materials can basically also be used regardless of their electrical conductivity. For example, an electrically conductive layer could also be produced with a metal foil. It is also conceivable to produce a compression moulded body with more than two moulded layers and, if applicable, also multiple layers by means of the device.

Since the ram units of the upper ram arrangement and the ram units of the lower ram arrangement are rotatable about the axis together with the die plate in the form of a rotor, the above-described filling of the mould segments, the feed of the film and the pressing of the moulded layers can during a rotational motion of the rotor take place within one individual revolution of the rotor by 360° or less. A pressing speed is then no longer dependent on the cycle of a press, but rather on the potential rotational speed of the rotor. Since the rotor rotates continuously, the ram units also no longer operate in a cycle, but rather are moved or positioned in dependence on their position relative to a rotation of the rotor. The filling device and the feed device, in contrast, are arranged stationarily relative to the rotating rotor. A multiplicity of compression moulded bodies can be cost-efficiently produced in dependence on the number of ram units and the number of revolutions of the rotor per minute.

The ram units of the upper ram arrangement may respectively comprise a hold-down device, wherein the film may be fixable on the die plate above the die by means of the hold-down device. The hold-down device may comprise, for example, a frame-like plate that surrounds the ram tool and can exert a pressing force upon the die plate by means of a spring. The hold-down device may alternatively also be realized in the form of multiple rod-shaped or plate-shaped hold-down elements that are spring-loaded. The hold-down device may be designed in such a way that the film is guided between the hold-down device and the die plate and fixed on the die plate by lowering the ram unit in the direction of the die plate. In this case, the ram tool may not be in contact with the film yet. The hold-down device can fix the film on the die plate at least during a downward motion of the ram tool in the direction of the die and shortly before reaching the die such that the ram tool can punch out the film and thereby produce the layer. The hold-down device prevents the film from shifting as a result of the punching process and the film can be carried along with the rotational speed of the rotor.

In an embodiment, the film may be a film strip that can be fed to the rotor tangentially by means of the feed device. Due to this tangential feed, the film strip can be respectively introduced into the rotational motion of the rotor or into the rotor. This tangential feed also allows a cycle-independent feed of the film strip because the film strip can completely overlap with at least one die. It would also be conceivable that the film strip is carried along with the rotational motion of the rotor by a certain distance. This can be realized if the film strip can be fixed on the die plate by means of a hold-down device.

The film strip may be fixable on the die plate by means of a multitude of ram units of the upper ram arrangement in such a way that the film strip can at least sectionally follow a rotational motion of the rotor along a circular arc on the die plate. In any case, the film strip can be tangentially fed to and transported away from the rotor. For example, a few of the respective ram units can fix the film strip on the die plate before, during and after punching out the film strip by means of the ram tool. Since the film strip is carried along on the die plate along a circular arc, it can also completely overlap with multiple dies. The feed device may furthermore comprise a delivery roll and a take-up roll for the film strip.

In order to prevent undesirable creasing or overlapping of the film strip during a tangential feed, the feed device may comprise stamping elements for buckling the film strip on one side. The stamping elements may consist, for example, of one or two rollers, between which the film strip passes. The one-sided buckling of the film strip may be realized in that the film strip is in the region of a lateral edge pleated or crimped transverse to a longitudinal direction of the film strip by means of the stamping elements. The one-sided buckling of the film strip may take place sectionally such that buckled regions of the film strip can be respectively arranged on the die plate between two dies. All in all, creasing or folding of the film strip in the region of a die can thereby be reliably prevented.

Additionally or alternatively, a multitude of film strips, which are arranged parallel to one another and respectively assigned to ram tools, may be tangentially fed to the rotor by means of the feed device. The risk of creasing or folding the film strip in the region of a die can be eliminated in that the film strip is as narrow as possible. This can be realized by utilizing multiple film strips that are arranged parallel to one another. In this context, it would be conceivable to utilize a number of film strips that corresponds to the number of dies or ram tools assigned to a ram unit.

The feed device may comprise cutting elements for separating a film strip into parallel partial film strips. The cutting elements may be knives or rollers that have cutting edges for separating the film strip. In this way, a comparatively wide film strip can also be fed to the rotor by means of the feed device. The film strip is also easier to handle and transport in this case.

In another embodiment, the film may be a film sheet that can be tangentially fed to the rotor by means of the feed device. The film sheet can be placed on the rotor between the upper ram arrangement and the die plate by means of the feed device such that it completely covers one die. The film sheet can also be produced by sectionally separating a film strip. However, it is in this case also essential that the film sheet is fed to the rotor tangentially if this rotor moves continuously.

In this context, it would be conceivable that the film sheet can be fed to a suction device of the upper ram arrangement by means of a conveyor belt of the feed device. For example, the conveyor belt may be arranged tangentially relative to the rotor and continuously feed film sheets to the upper ram arrangement. The film sheets located on the conveyor belt can be respectively taken hold of by a ram unit of the upper ram arrangement with the aid of the suction device. The suction device may be designed in such a way that one film sheet can be fixed on each ram unit of the upper ram arrangement by means of suction. For example, the suction device may be arranged or realized on a hold-down element of a ram unit, wherein the suction device can generate a vacuum for fixing film sheets on the ram units by means of suction.

The upper ram arrangement and the lower ram arrangement may respectively comprise 10 to 30 ram units, preferably up to 100 ram units, particularly 24 ram units, wherein the die plate may comprise a number of dies or die arrangements that corresponds to the number of ram units. Accordingly, the die plate may also comprise a multitude of dies that are respectively assigned to one opposite pair of ram units. In this way, a number of compression moulded bodies that corresponds to the number of assigned dies or a die arrangement can be simultaneously pressed with one pair of ram units or one ram unit pair. For example, if 24 pairs of ram units are provided, which respectively consist of a ram unit of the upper ram arrangement and a ram unit of the lower ram arrangement, and three dies are respectively assigned to each pair, 216,000 compression moulded bodies per hour can be produced at a rotational speed of the rotor of 50 rpm.

The device may also be designed for producing a multi-layer compression moulded body with the first moulded layer and at least one second moulded layer. In this case, the ram tools can after pressing the first moulded layer be arranged in such a way that an additional mould segment is arranged or formed in the die and can be filled with moulding material by means of the filling device. A second moulded layer can then be produced by means of repeated pressing with the ram tool.

The device may comprise a first filling device, wherein a first mould segment formed in the die can be filled with moulding material for producing the first moulded layer by means of the first filling device, wherein the device may comprise a second filling device, and wherein a second mould segment formed in the die can be filled with moulding material for producing the second moulded layer by means of the second filling device. The first filling device may be arranged on the rotor, for example, directly opposite of the second filling device, wherein the feed device may be arranged between the filling devices such that the first mould segment can initially be filled, the layer can subsequently be produced by means of the film and the second mould segment can ultimately be filled. An arrangement of additional filling devices may be provided on the rotor in order to produce additional moulded layers.

Accordingly, the feed device may be arranged on the rotor downstream of the first filling device and upstream of the second filling device referred to the rotating direction of the rotor.

In this case, the layer may be produced in the form of a separation layer between the first moulded layer and the second moulded layer.

The layer may additionally or alternatively be produced in the form of a cover layer. For example, the compression moulded body may comprise only a single outer cover layer or two outer cover layers. In addition, one or more separation layers may be provided if multiple moulded layers are produced.

The device may furthermore comprise a delivery device, wherein compression moulded bodies can be transported away from the rotor by means of the delivery device. For example, the compression moulded bodies can be upwardly ejected from the die due to a motion of the ram tool of a ram unit of the lower ram arrangement relative to the die plate. The delivery device can then collect the ejected compression moulded bodies, which are in motion due to the rotation of the rotor, and transport these compression moulded bodies away from the rotor. For example, the delivery device may be a conveyor belt that transports the compression moulded bodies to further use or processing. The delivery device may also comprise a metal sheet or a funnel-shaped metal sheet, which is adapted to the die plate and into which the compression moulded bodies are moved. The delivery device may be arranged downstream of or between a first filling device and, if applicable, a second filling device or downstream of the second filling device referred to the rotating direction of the rotor.

The ram unit may comprise a multiplicity of ram tools. In this case, the number of ram tools preferably conforms to the number of dies that can be assigned to a ram unit.

The rotor can preferably be realized in the form of a rotary press. Compression moulded bodies with a cover layer or separation layer can only be produced with the rotary press due to the fact that a film can be fed to the rotary press by means of the feed device.

The invention proposes the utilization of a device according to one of claims 1-18 for producing a compression moulded body with at least one first moulded layer and a layer produced on the first moulded layer by means of a film. With respect to the advantageous effects of the inventive utilization, we refer to the description of the advantages of the inventive device. Other advantageous embodiments of the utilization can be gathered from the dependent claims that refer to claim 1.

In the inventive method for producing a compression moulded body with at least one first moulded layer by means of a device that comprises an upper ram arrangement and a lower ram arrangement, which respectively have at least one ram unit, ram tools of the ram units are axially displaced relative to one another in a die of a mould of the device, wherein mould segments are formed in the mould by means of the ram tools, wherein the die is filled with moulding material by means of a filling device of the device, wherein the upper ram arrangement and the lower ram arrangement respectively comprise a multiplicity of annularly arranged ram units, wherein the mould is realized in the form of a die plate and forms a rotor, which rotates about an axis, together with the ram units, wherein a film is fed to the rotor by means of a feed device such that it lies between a ram tool and a die formed in the die plate, and wherein a layer is produced on the first moulded layer by means of the film. With respect to the advantageous effects of the inventive method, we refer to the description of the advantages of the inventive device.

During a rotation of the rotor, a first mould segment formed in the die can be filled with moulding material for producing the first moulded layer by means of a first filling device of the device, wherein the film can be tangentially fed to the rotor by means of the feed device and fixed on the die plate by means of a hold-down device of the ram units of the upper ram arrangement, wherein the first moulded layer and the layer in the form of a separation layer can be produced by compressing the moulding material in order to punch out the film with the ram tool, wherein a second mould segment formed in the die can be filled with moulding material for producing the second moulded layer by means of a second filling device, and wherein the second moulded layer can be produced by compressing the moulding material with the ram tool.

Alternatively, a first mould segment formed in the die can during a rotation of the rotor be filled with moulding material for producing the first moulded layer by means of a first filling device of the device, wherein the film can be tangentially fed to the rotor by means of the feed device and fixed on the die plate by means of a hold-down device of the ram units of the upper ram arrangement, and wherein the first moulded layer and the layer in the form of a cover layer can be produced by compressing the moulding material in order to punch out the film with the ram tool.

Other advantageous embodiments of the method can be gathered from the dependent claims that refer to claim 1.

Preferred embodiments of the invention are described in greater detail below with reference to the attached drawings.

In these drawings:

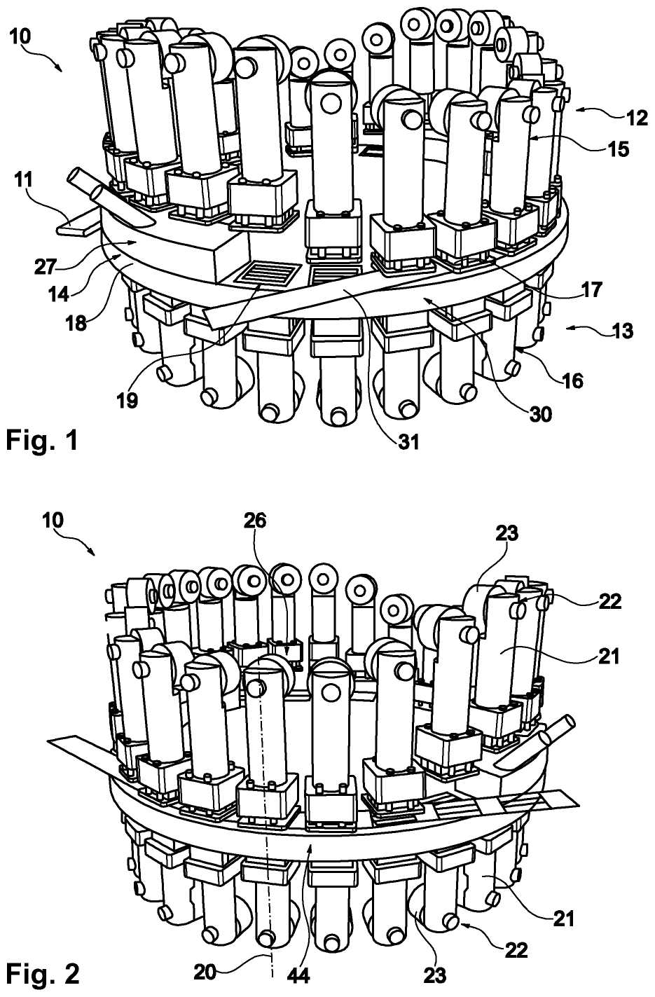

FIG. 1 shows a device in the form of a perspective view;

FIG. 2 shows the device in the form of a second perspective view;

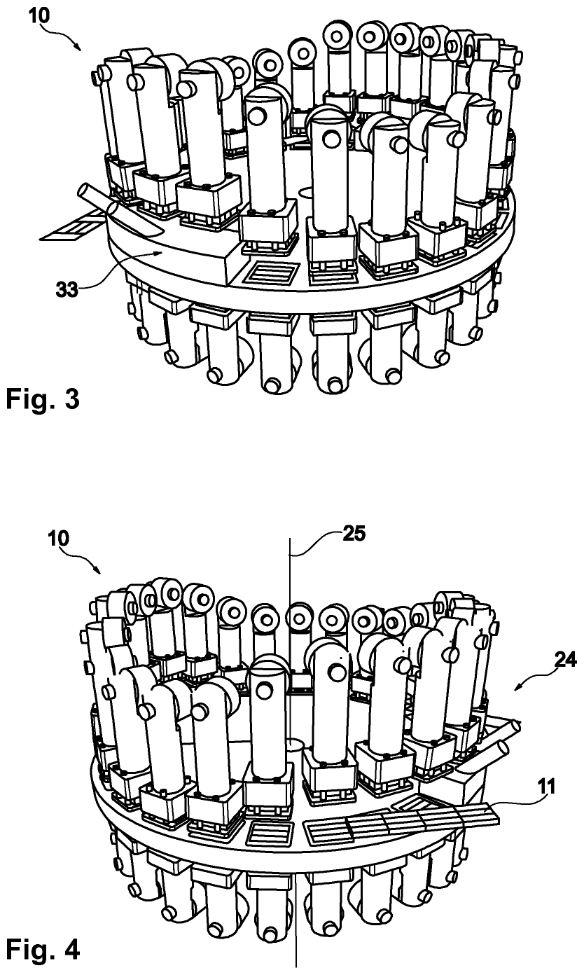

FIG. 3 shows the device in the form of a third perspective view;

FIG. 4 shows the device in the form of a fourth a perspective view;

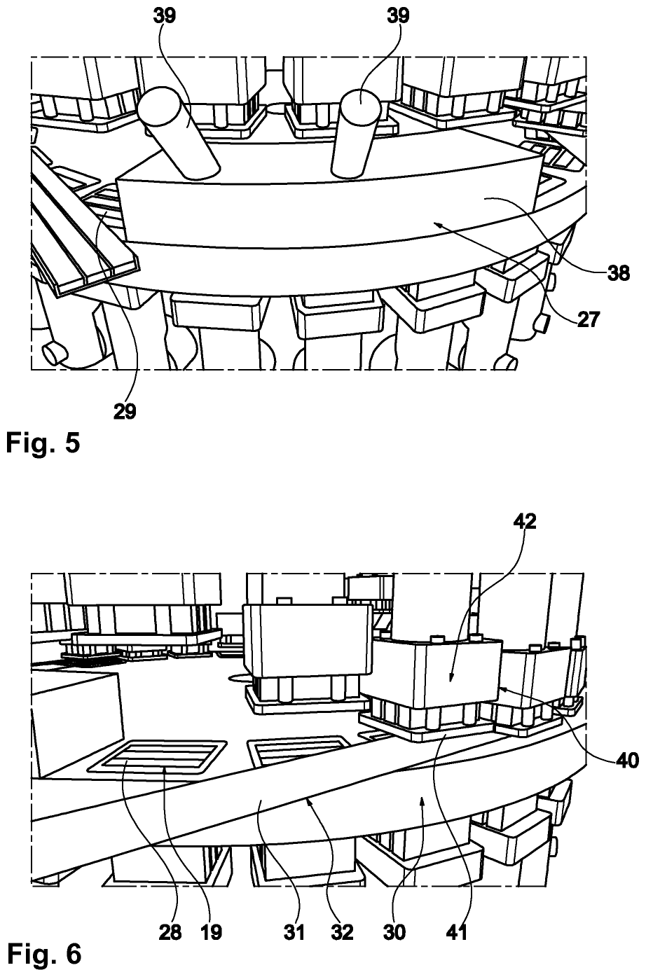

FIG. 5 shows the device in the form of a detailed perspective view;

FIG. 6 shows the device in the form of a second detailed perspective view;

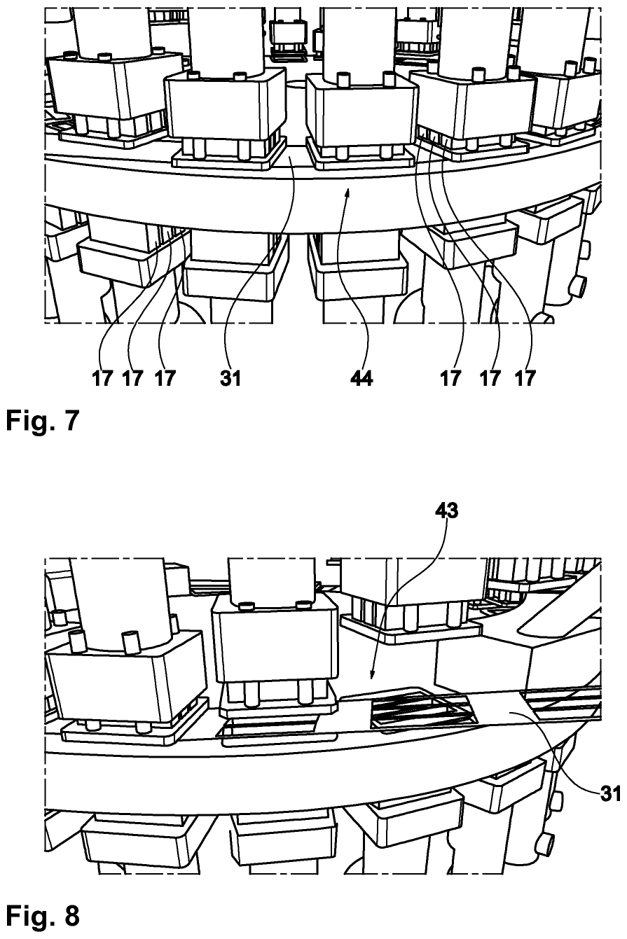

FIG. 7 shows the device in the form of a third detailed perspective view;

FIG. 8 shows the device in the form of a fourth detailed perspective view;

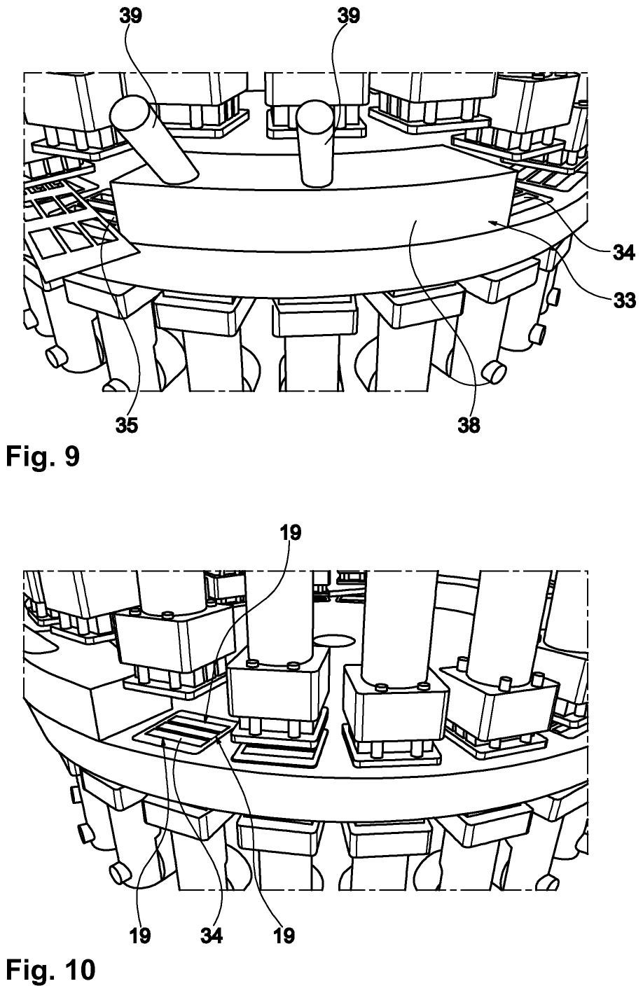

FIG. 9 shows the device in the form of a fifth detailed perspective view;

FIG. 10 shows the device in the form of a sixth detailed perspective view;

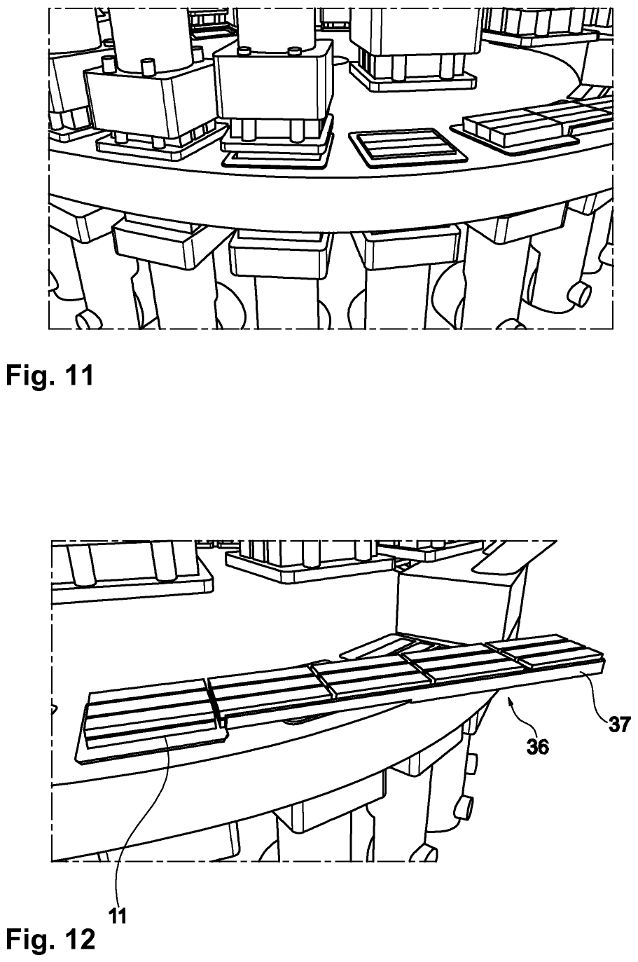

FIG. 11 shows the device in the form of a seventh detailed perspective view;

FIG. 12 shows the device in the form of an eighth detailed perspective view;

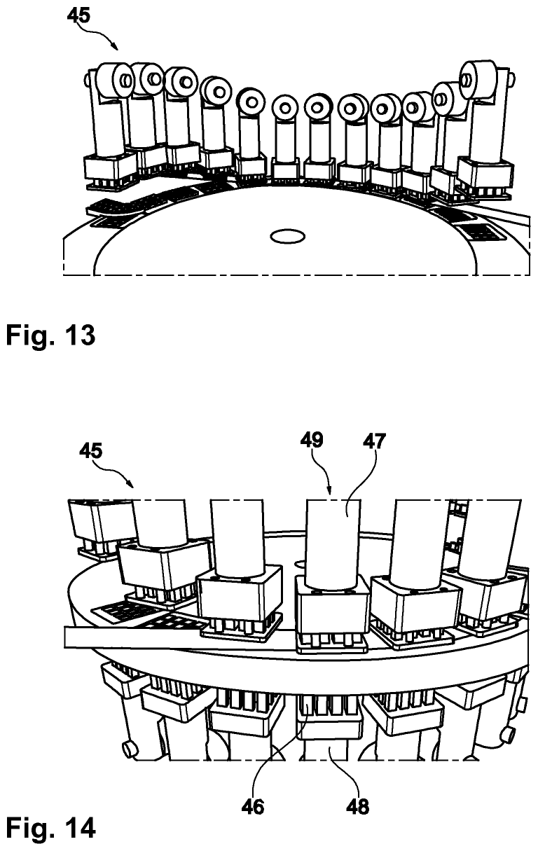

FIG. 13 shows a second embodiment of a device in the form of a detailed perspective view;

FIG. 14 shows the device according to FIG. 13 in the form of a second detailed perspective view;

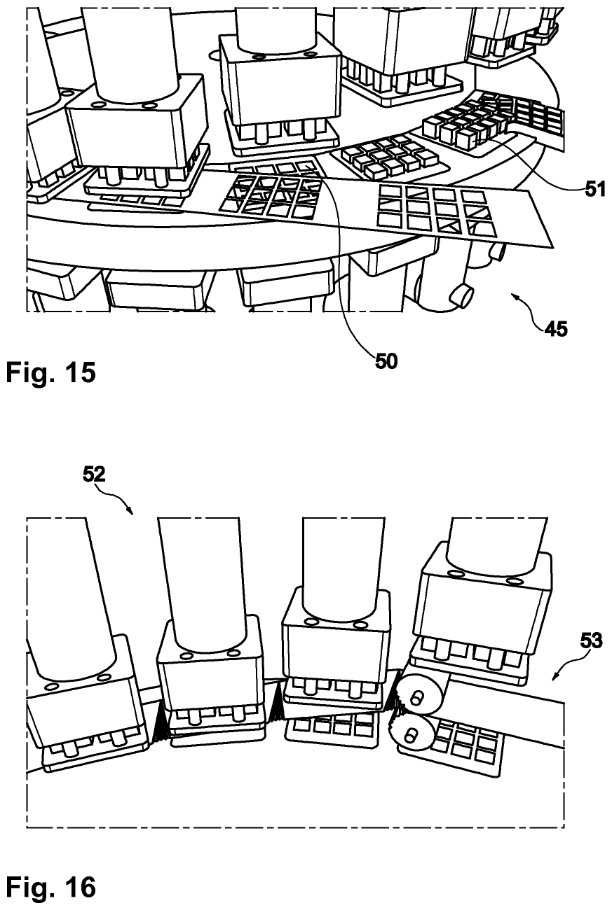

FIG. 15 shows the device according to FIG. 13 in the form of a third detailed perspective view;

FIG. 16 shows the device according to FIG. 13 in the form of a fourth detailed perspective view;

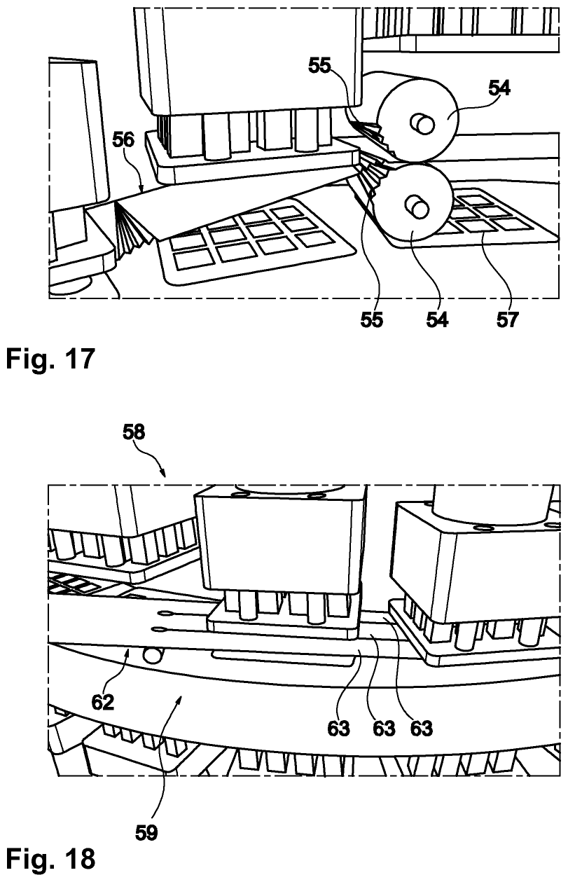

FIG. 17 shows a third embodiment of a device in the form of a detailed perspective view;

FIG. 18 shows the device according to FIG. 16 in the form of a second detailed perspective view;

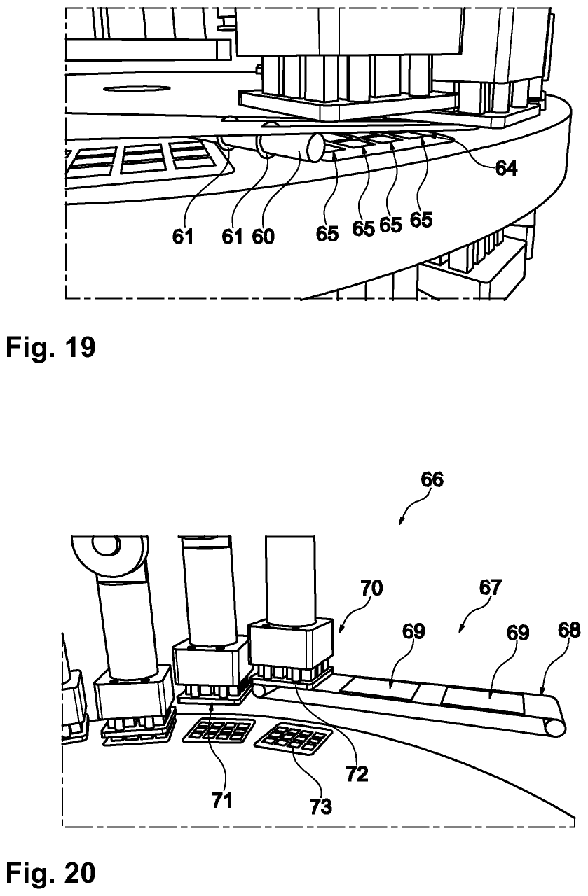

FIG. 19 shows a fourth embodiment of a device in the form of a detailed perspective view;

FIG. 20 shows the device according to FIG. 18 in the form of a second detailed perspective view; and

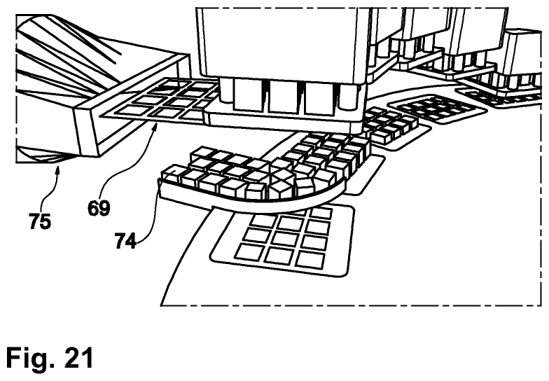

FIG. 21 shows a fifth embodiment of a device in the form of a detailed perspective view.

A synopsis of FIGS. 1-12 shows a device 10 for producing a multi-layer compression moulded body 11 in the form of various views. The device 10 is illustrated in simplified form for the purpose of better visualization. The device 10 comprises an upper ram arrangement 12 and a lower ram arrangement 13, as well as a mould 14. The upper ram arrangement 12 comprises 24 ram units 15 and the lower ram arrangement 13 comprises 24 ram units 16, wherein said ram units respectively have three rectangular ram tools 17. The mould is realized in the form of a die plate 18 with dies formed therein, wherein said dies respectively correspond to the ram tools 17. The ram units 15 and 16 are respectively mounted in a not-shown ram guide with their ram shaft 21 so as to be longitudinally movable along a longitudinal axis 20. A roll 23 is rotatably mounted on an end 22 of each ram shaft 21, wherein the rolls 23 roll on not-shown annular plate cams such that the ram units 15 and 16 reach the positions shown. The ram units 15 and 16 from a rotor 24, which is rotatable about an axis 25, together with the die plate 18. Consequently, a rotation of the rotor 24 causes a continuous motion of the ram units 15 and 16 and a displacement of the ram tools 17 relative to the dies 19. One ram unit 15 and one ram unit 16 respectively form a corresponding ram unit pair 26, which is assigned to the three dies 19.

The device 10 also comprises a first filling device 27, by means of which a first moulding material 28 is filled into a first mould segment 29 that is formed in the die 19 by positioning the ram tool 17 accordingly. The device 10 furthermore comprises a feed device 30, by means of which a film 31 in the form of a film strip 32 can be fed to and transported away from the rotor 24. A second filling device 33 follows the feed device 30 in the rotating direction of the rotor 24, wherein a second moulding material 34 is filled into a second mould segment 35, which is formed in the die 19 by positioning the ram tool 17 accordingly, by means of the second filling device. A delivery device 36 is arranged on the rotor 34 downstream of the second filling device 33 and upstream of the first filling device 27, wherein the delivery device is realized in the form of a sheet metal rail 37 for receiving the compression moulded bodies 11 ejected from the dies 19.

A synopsis of FIGS. 5-12 shows a sequence of a method for producing the multi-layer compression moulded body 11 in greater detail. The ram tools 17 in the region of the first filling device 27, which is merely illustrated schematically in the form of a box 38 with a material feed line 39, are initially lowered in the dies 19 to such a level that the first mould segment 29 is formed. The film strip 32 is tangentially fed to the rotor 24 above the dies filled with the first moulding material 28. The ram units 15 are then lowered to such a level that the film strip 32 is respectively clamped or fixed on the die plate 18. In contrast to the ram units 16, the ram units 15 respectively comprise hold-down devices 40. The hold-down device 40 is realized in the form of a hold-down element 41 that surrounds the ram tools 17 and has a longitudinal guide 42 in the direction of the longitudinal axis 20, wherein the longitudinal guide 42 exerts a spring force upon the hold-down element 41. In this way, the film strips 32 can be fixed on a surface 43 of the die plate 18 and guided along a circular arc 44, wherein each die 19 within the circular arc 44 is completely covered by the film 31. The film strip 32 is furthermore punched out by means of the ram tools 17 such that a not-shown separation layer is produced of the film 31 and the first moulding material 28 is compressed into a likewise not-shown first moulded layer. The punched-out film strip 32 is then once again tangentially guided away from the rotor 24. In this case, the film strip 32 is stored on not-shown rolls.

Subsequently, the ram tools 17 are simultaneously lowered in the respective dies 19 to such a level that the second mould segment 35 is formed, which is then filled with the second moulding material 34 at the second filling device 33. The second filling device 33 is likewise illustrated in the form of a box 38 with material feed lines 39. After the second mould segments have been filled, the not-shown second moulded layer is pressed by means of a motion of the ram tools 17 in the dies 19. The ram tools 17 of the ram units 16 are then moved upward to such a level that the compression moulded bodies 11 are ejected from the dies 19. The compression moulded bodies 11 then reach the sheet metal rail 37 and can be transported to further processing or use.

FIGS. 13-15 show a device 45, which is only partially illustrated and, in contrast to the device according to FIGS. 1-12, respectively comprises 12 ram tools 46 on the ram units 47 and 48. Consequently, 12 dies 50 are also assigned to a ram unit pair 49. Essentially cuboid compression moulded bodies 51 are produced in this example.

A synopsis of FIGS. 16 and 17 shows a device 52 with a feed device 53, which comprises two rollers 54 with stamping elements 55 for buckling a film strip 56 on one side. Due to this buckling, the film strip 56 is sectionally folded multiple times, wherein the plane, unfolded film strip 56 is always placed above the dies 57 by means of the feed device 53.

FIGS. 18 and 19 show a device 58 with a feed device 59, wherein the feed device 59 comprises a roller 60 with cutting elements 61. The cutting elements 61 separate the film strip 62 into three parallel film strips or partial film strips 63. Each of the partial film strips 63 can then cover one row 64 of dies 65.

FIGS. 20 and 21 show a device 66 with a feed device 67, which comprises a conveyor belt 68 for tangentially feeding film sheets 68. A not-shown suction device 71 is arranged on a hold-down device 70 and generates a vacuum underneath a hold-down element 72 of the hold-down device 70. In this way, the film sheets 69 can be fixed on the hold-down element 72 and positioned above the dies 73. After pressing the compression moulded bodies 74 and punching out the film sheets 69, the punched-out film sheets 69 can be once again removed from the hold-down element 72 by means of a suction device 75.

1. A device (10, 45, 52, 58, 66) for producing a compression moulded body (11, 51, 74) with at least one first moulded layer, wherein the device comprises an upper ram arrangement (12) and a lower ram arrangement (13), which respectively have at least one ram unit (15, 16, 47, 48), and a mould (14), wherein the ram unit has at least one ram tool (17, 46), wherein the ram tools are designed for being axially displaceable relative to one another in a die (19, 50, 57, 65, 73) of the mould in such a way that mould segments (29, 35) can be formed in the mould by means of the ram tools, wherein the device has a filling device (27, 33), and wherein the die can be filled with moulding material (28, 34) by means of the filling device,
characterized in
that the upper ram arrangement and the lower ram arrangement respectively comprise a multiplicity of annularly arranged ram units, wherein the mould is realized in the form of a die plate (18) and forms a rotor (24), which is designed to be rotatable about an axis (25), together with the ram units, wherein the device has a feed device (30, 53, 59, 67), wherein a film (31) can be fed to the rotor by means of the feed device such that it lies between a ram tool and a die formed in the die plate, and wherein a layer can be produced on the first moulded layer by means of the film.

2. The device according to claim 1,
characterized in
that ram units (15, 16, 47, 48) of the upper ram arrangement (12) respectively comprise a hold-down device (40, 70), wherein the film (31) can be fixed on the die plate (18) above the die (19, 50, 57, 65, 73) by means of the hold-down device.

3. The device according to claim 1,
characterized in
that the film (31) is a film strip (32, 56, 62, 68), which can be tangentially fed to the rotor (24) by means of the feed device (30, 53, 59).

4. The device according to claim 3,
characterized in
that the film strip (32, 56, 62, 68) can be fixed on the die plate (18) by means of a multitude of ram units (15, 16, 47, 48) of the upper ram arrangement (12) in such a way that the film strip can at least sectionally follow a rotational motion of the rotor (24) along a circular arc (44) on the die plate.

5. The device according to claim 3,
characterized in
that the feed device (53) comprises stamping elements (55) for buckling the film strip (56) on one side.

6. The device according to claim 3,
characterized in
that a multitude of film strips, which are arranged parallel to one another and respectively assigned to ram tools (17, 46), can be tangentially fed to the rotor (24) by means of the feed device (59).

7. The device according to claim 6,
characterized in
that the feed device (59) comprises cutting elements (61) for separating a film strip (62) into parallel partial film strips (63).

8. The device according to claim 1,
characterized in
that the film is a film sheet (69), which can be tangentially fed to the rotor (24) by means of the feed device (67).

9. The device according to claim 8,
characterized in
that the film sheet (69) can be fed to a suction device (71) of the upper ram arrangement (12) by means of a conveyor belt (68) of the feed device (67).

10. The device according to claim 1,
characterized in
that the ram units (15, 47) of the upper ram arrangement (12) respectively comprise a suction device (71), wherein the film can be fixed on the ram unit above the die (19, 50, 57, 65, 73) by means of the suction device.

11. The device according to claim 1,
characterized in
that the device (10, 45, 52, 58, 66) is designed for producing a multi-layer compression moulded body (11, 51, 74) with the first moulded layer and at least one second moulded layer.

12. The device according to claim 11,
characterized in
that the device (10, 45, 52, 58, 66) comprises a first filling device (27), wherein a first mould segment (29) formed in the die (19, 50, 57, 65, 73) can be filled with moulding material (28) for producing the first moulded layer by means of the first filling device, wherein the device comprises a second filling device (33), and wherein a second mould segment (35) formed in the die can be filled with moulding material (34) for producing the second moulded layer by means of the second filling device.

13. The device according to claim 12,
characterized in
that the feed device (30, 53, 59, 67) is arranged on the rotor downstream of the first filling device (27) and upstream of the second filling device (33) referred to the rotating direction of the rotor (24).

14. The device according to claim 11,
characterized in
that the layer is produced in the form of a separation layer.

15. The device according to claim 1,
characterized in
that the layer is produced in the form of a cover layer.

16. The device according to claim 1,
characterized in
that the device (10, 45, 52, 58, 66) comprises a delivery device (36), wherein compression moulded bodies (11, 51, 74) can be transported away from the rotor (24) by means of the delivery device.

17. The device according to claim 1,
characterized in
that the ram unit (15, 16, 47, 48) comprises a multiplicity of ram tools (17, 46).

18. The device according to claim 1,
characterized in
that the rotor (24) is realized in the form of a rotary press.

19. A utilization of a device (10, 45, 52, 58, 66) according to claim 1 for producing a compression moulded body (11, 51, 74) with at least one first moulded layer and a layer produced on the first moulded layer by means of a film (31).

20. A method for producing a compression moulded body (11, 51, 74) with at least one first moulded layer by means of a device (10, 45, 52, 58, 66), wherein the device comprises an upper ram arrangement (12) and a lower ram arrangement (13), which respectively have at least one ram unit (15, 16, 47, 48), wherein ram tools (17, 46) of the ram units are axially displaced relative to one another in a die (19, 50, 57, 65, 73) of a mould (14) of the device, wherein mould segments (29, 35) are formed in the mould by means of the ram tools, and wherein the die is filled with moulding material (28, 43) by means of a filling device (27, 33) of the device,
characterized in that the upper ram arrangement and the lower ram arrangement respectively comprise a multiplicity of annularly arranged ram units, wherein the mould is realized in the form of a die plate (18) and forms a rotor (24), which rotates about an axis (25), together with the ram units, wherein a film (31) is fed to the rotor by means of a feed device (30, 53, 59, 67) of the device such that it lies between a ram tool and a die formed in the die plate, and wherein a layer is produced on the first moulded layer by means of the film.

21. The method according to claim 20,
characterized in
that a first mould segment (29) formed in the die (19, 50, 57, 65, 73) is during a rotation of the rotor (24) filled with moulding material (28) for producing the first moulded layer by means of a first filling device (27) of the device (10, 45, 52, 58, 66), wherein the film (31) can be tangentially fed to the rotor by means of the feed device (30, 53, 59, 67) and fixed on the die plate (18) by means of a hold-down device (40, 70) of the ram units (15, 47) of the upper ram arrangement (12), wherein the first moulded layer and the layer in the form of a separation layer are produced by compressing the moulding material and punching out the film with the ram tool (17, 46), wherein a second mould segment (35) formed in the die is filled with moulding material (34) for producing the second moulded layer by means of a second filling device (33) of the device, and wherein the second moulded layer is produced by compressing the moulding material with the ram tool.

22. The method according to claim 20,
characterized in
that a first mould segment (29) formed in the die (19) is during a rotation of the rotor (24) filled with moulding material (28) for producing the first moulded layer by means of a first filling device (27) of the device (10), wherein the film (31) can be tangentially fed to the rotor by means of the feed device (30) and fixed on the die plate (18) by means of a hold-down device (40) of the ram units (15) of the upper ram arrangement (12), and wherein the first moulded layer and the layer in the form of a cover layer can be produced by compressing the moulding material and punching out the film with the ram tool (17).
